(19) United States
(12) Patent Application Publication
(10) Pub. No.: US 2026/0368168 A1
(43) Pub. Date: Nov. 19, 2026

(54) QUERY PLAN PROCESSING METHOD AND APPARATUS

(71) Applicant: CLOUD INTELLIGENCE ASSETS HOLDING (SINGAPORE) PRIVATE LIMITED, Singapore (SG)

(72) Inventors: Yuhan LI, Hangzhou (CN); Renjie LOU, Hangzhou (CN); Ziming WANG, Hangzhou (CN); Xintao LIAO, Hangzhou (CN)

(21) Appl. No.: 19/515,386

(22) PCT Filed: Aug. 5, 2024
(86) PCT No.: PCT/CN2024/109709

§ 371 Date: Feb. 27, 2026

(30) Foreign Application Priority Data
Sep. 4, 2023 (CN) 202311137689.8

(51) Int. Cl. G06F 16/2453; G06F 16/2455; G06F 16/28

(52) U.S. Cl. CPC G06F 16/24542; G06F 16/24553; G06F 16/283

(57) ABSTRACT

A query plan processing method and apparatus are provided in one or more embodiments of the present disclosure. The method includes: dividing, in response to a to-be-executed query plan, query execution steps included in the query plan into a plurality of query execution groups; and sequentially scheduling, according to a scheduling sequence of the plurality of query execution groups, query execution groups that meet a scheduling starting condition into an execution queue, where the scheduling starting condition corresponding to any query execution group of the plurality of query execution groups includes: a previous query execution group of the any query execution group starts to generate execution result data.

### CROSS-REFERENCE TO RELATED APPLICATION

The present disclosure is a National Stage of International Application No. PCT/CN2024/109709, filed on Aug. 5, 2024, which claims priority to Chinese Patent Application No. 202311137689.8, filed with the China National Intellectual Property Administration on Sep. 4, 2023 and entitled “QUERY PLAN PROCESSING METHOD AND APPARATUS”. These applications are incorporated herein by reference in their entireties.

### TECHNICAL FIELD

One or more embodiments of the present disclosure relate to the field of big data, and in particular, to a query plan processing method and apparatus.

### BACKGROUND

A real-time data warehouse is a concept relative to an offline data warehouse. The real-time data warehouse further meets a timeliness requirement based on the offline data warehouse, and resolves a problem of low data timeliness of the offline data warehouse. The real-time data warehouse requires a service platform to provide online query and offline computing services, that is, the service platform needs to have both a capability of quickly responding to an online task and a capability of processing a complex offline task.

In a related technology, the service platform meets the foregoing requirement by integrating two types of computing engines: an interactive analysis engine for processing the online task and a big data engine for processing the offline task. However, this method not only increases operations and maintenance costs by requiring simultaneous operations and maintenance of the two types of computing engines, but also increases complexity of user operations by requiring a user to select between the two types of computing engines after submitting a task.

### SUMMARY

In view of this, a query plan processing method and apparatus are provided in one or more embodiments of the present disclosure, to resolve shortcomings in a related technology.

To achieve the foregoing objective, the following technical solutions are provided in one or more embodiments of the present disclosure.

According to a first aspect of the one or more embodiments of the present disclosure, a query plan processing method is provided, where the method includes:
dividing, in response to a to-be-executed query plan, query execution steps included in the query plan into a plurality of query execution groups; and
sequentially scheduling, according to a scheduling sequence of the plurality of query execution groups, query execution groups that meet a scheduling starting condition into an execution queue, where the scheduling starting condition corresponding to any query execution group of the plurality of query execution groups includes: a previous query execution group of the any query execution group starts to generate execution result data.

According to a second aspect of the one or more embodiments of the present disclosure, a query plan processing apparatus is provided, where the apparatus includes:
a dividing unit, configured to divide, in response to a to-be-executed query plan, query execution steps included in the query plan into a plurality of query execution groups; and
a scheduling unit, configured to sequentially schedule, according to a scheduling sequence of the plurality of query execution groups, query execution groups that meet a scheduling starting condition into an execution queue, where the scheduling starting condition corresponding to any query execution group of the plurality of query execution groups includes: a previous query execution group of the any query execution group starts to generate execution result data.

According to a third aspect of the one or more embodiments of the present disclosure, an electronic device is provided, including:
a processor; and
a memory, configured to store processor-executable instructions, where
the processor implements steps of the method according to the first aspect by running the executable instructions.

According to a fourth aspect of the one or more embodiments of the present disclosure, a computer-readable storage medium is provided, storing computer instructions, where when the instructions are executed by a processor, steps of the method according to the first aspect are implemented.

According to a fifth aspect of one or more embodiments of the present disclosure, a computer program is provided, where when the program is executed by a processor, steps of the method according to the first aspect are implemented.

As can be seen from the foregoing technical solutions, based on the query plan processing method and apparatus provided in the one or more embodiments of the present disclosure, in one aspect, the query execution steps included in the query plan are divided into the plurality of query execution groups, so that the plurality of query execution groups can be sequentially scheduled into the execution queue according to the scheduling sequence. Even if the query plan is complex, the query plan can be divided into the plurality of query execution groups for sequential scheduling, thereby implementing processing of a complex offline task. In another aspect, the scheduling starting condition for the plurality of query execution groups is set as: the previous query execution group starts to generate the execution result data, so that any query execution group can be scheduled into the execution queue when the previous query execution group starts to generate the execution result data, instead of being scheduled into the execution queue only when execution of the previous query execution group is completed. This improves scheduling efficiency of the query execution groups, thereby accelerating a speed of responding to an online task. In addition, because the foregoing method can not only process the complex offline task, but also quickly respond to the online task, the foregoing method can meet a requirement of a real-time data warehouse through operations and maintenance of only one type of computing engine, thereby reducing operations and maintenance costs, and reducing complexity of user operations.

### BRIEF DESCRIPTION OF DRAWINGS

FIG. 1 is a schematic diagram of a query plan processing framework according to an exemplary embodiment.

FIG. 2 is a flowchart of a query plan processing method according to an exemplary embodiment.

FIG. 3 is a schematic diagram of a tree-structured query plan according to an exemplary embodiment.

FIG. 4 is a schematic diagram of a time consumption comparison according to an exemplary embodiment.

FIG. 5 is a schematic diagram of query execution group division according to an exemplary embodiment.

FIG. 6 is a flowchart of a data shuffle method according to an exemplary embodiment.

FIG. 7 is a schematic structural diagram of a device according to an exemplary embodiment.

FIG. 8 is a block diagram of a query plan processing apparatus according to an exemplary embodiment.

### DESCRIPTION OF EMBODIMENTS

Exemplary embodiments are described in detail herein, and examples of the exemplary embodiments are shown in the accompanying drawings. When the following descriptions relate to the accompanying drawings, unless indicated otherwise, same numbers in different accompanying drawings represent same or similar elements. Implementations described in the following exemplary embodiments do not represent all implementations consistent with one or more embodiments of the present disclosure. On the contrary, the implementations are merely examples of the apparatuses and methods described in detail in the appended claims that are consistent with some aspects of the one or more embodiments of the present disclosure.

It should be noted that in other embodiments, steps of a corresponding method are not necessarily performed in a sequence shown and described in the present disclosure. In some other embodiments, the method may include more or fewer steps than the steps described in the present disclosure. In addition, a single step described in the present disclosure may be divided into a plurality of steps for description in other embodiments; and a plurality of steps described in the present disclosure may be combined into a single step for description in other embodiments.

User information (including, but not limited to, user equipment information, user personal information, and the like) and data (including, but not limited to, data for analysis, stored data, displayed data, and the like) involved in this application are both information and data that are authorized by a user or that are sufficiently authorized by all parties. In addition, relevant data needs to be collected, used, and processed by complying with relevant laws, regulations, and standards of relevant countries and regions, and a corresponding operation entry is provided for the user to select to authorize or reject.

To further describe the one or more embodiments of the present disclosure, the following embodiments are provided.

A real-time data warehouse is a concept relative to an offline data warehouse. The real-time data warehouse further meets a timeliness requirement based on the offline data warehouse, and resolves a problem of low data timeliness of the offline data warehouse. The real-time data warehouse requires a service platform to provide online query and offline computing services, that is, the service platform needs to have both a capability of quickly responding to an online task and a capability of processing a complex offline task.

In a related technology, the service platform meets the foregoing requirement by integrating two types of computing engines. The two types of computing engines include an interactive analysis engine, for example, an MPP (Massively Parallel Processing) engine, and a big data engine, for example, a BSP (Bulk Synchronous Parallel) engine. When processing a query task submitted by a user, both the two types of computing engines will generate a corresponding query plan. The query plan includes a set of query execution steps to be executed to complete the query task. As shown in FIG. 1, a query plan 10 includes four query execution steps: a query execution step 101, a query execution step 102, a query execution step 103, and a query execution step 104. An execution sequence of the four query execution steps is the foregoing described sequence. The computing engines may schedule the four query execution steps into an execution queue. Being in the execution queue does not mean that the query execution steps can be executed immediately. A next query execution step will start to be executed only when execution of a previous query execution step is completed. For example, even if the query execution step 101 and the query execution step 102 are scheduled into the execution queue simultaneously, the execution queue will first execute the query execution step 101, and start to execute the query execution step 102 when execution of the query execution step 101 is completed. However, even if a query execution step in the execution queue does not start to be executed, the query execution step still occupies a part of resources.

Scheduling in a computer is a method for allocating a resource required for work. The resource may refer to a virtual computing resource, such as a thread, a process, or a data stream; and the resource may alternatively refer to a hardware resource, such as a processor, a network connection, or an expansion card. A program performing scheduling work is referred to as a scheduler, and a common implementation thereof is to enable all computing resources to be in a busy state, and allow a plurality of users to share system resources effectively and simultaneously, or achieve a specified quality of service. In a distributed database, a scheduler enables a plurality of query tasks submitted by a user or a plurality of query execution steps divided from a query task to be processed in parallel in an execution process, so that resources of an entire distributed system can be fully used.

As described above, in the related technology, the requirement of the real-time data warehouse is met by integrating features of the two types of computing engines, and a Presto engine is precisely one such engine. The Presto engine implements a scheduler that supports both the MPP engine and the BSP engine. When processing a query plan corresponding to the online task, the scheduler uses an all-at-once scheduling algorithm, that is, schedules all query execution steps into the execution queue simultaneously, to achieve a quick response to the online task. However, when the query plan is relatively complex, in the method, many query execution steps are scheduled into the execution queue at once, causing a problem of resource contention and waste.

When processing a query plan corresponding to the offline task, the scheduler uses a phased scheduling algorithm, that is, divides query execution steps into a plurality of query execution phases and schedules a next query execution phase into the execution queue only after execution of a previous query execution phase is completed, to handle the complex offline task. The method resolves the problem of resource contention and waste caused by the all-at-once scheduling algorithm. However, in the method, the next query execution phase can be scheduled into the execution queue only after the execution of the previous query execution phase is completed. Because of time required for resource scheduling, scheduling efficiency of the method is limited. Consequently, efficiency of processing the query task is limited, and a speed of responding to the query task is reduced.

In addition, integration of the two types of computing engines not only requires operations and maintenance to be performed on the two types of computing engines simultaneously, increasing operations and maintenance costs, but also requires a user to make a choice between the two types of computing engines after submitting the task, increasing complexity of user operation.

To resolve shortcomings in the related technology, the present disclosure provides a query plan processing method.

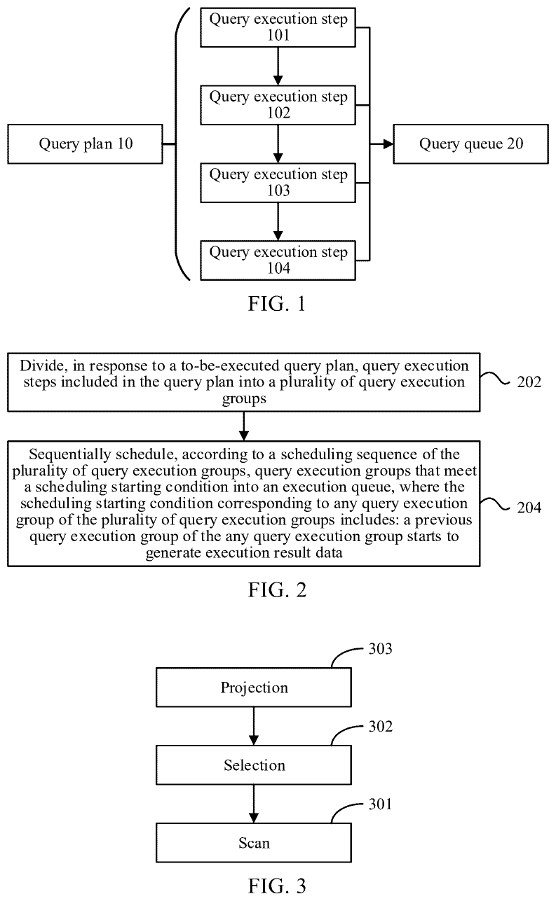

FIG. 2 is a flowchart of a query plan processing method according to an exemplary embodiment. As shown in FIG. 2, the method includes at least the following steps.

Step 202: Divide, in response to a to-be-executed query plan, query execution steps included in the query plan into a plurality of query execution groups.

When a user submits a query task, a service platform may generate a corresponding query plan for the query task submitted by the user. The query plan has a tree structure with physical operators as a connection, and each physical operator may be regarded as an iterator. One query plan may include a plurality of query execution steps, and each query execution step may be regarded as a node in the tree structure. A computing engine may be regarded as a virtual machine processing the tree structure, and during processing, the computing engine processes nodes from bottom to top.

The query plan of the tree structure will be explained in detail below with reference to FIG. 3. FIG. 3 is a schematic diagram of a query plan according to an exemplary embodiment. As shown in FIG. 3, the query plan has a tree structure, and three query execution steps included in the query plan may be regarded as three nodes in the tree structure, including a query execution step 301 to a query execution step 303. According to a bottom-up processing sequence (where an arrow in the tree structure is used to identify a dependency relationship among the query execution steps and does not represent the processing sequence), an execution sequence of the three query execution steps is from the query execution step 301 to the query execution step 303. An operator corresponding to the query execution step 301 is a Scan operator, and the Scan operator is used to read data from a table; an operator corresponding to the query execution step 302 is a Selection operator, and the Selection operator is used to select, from the table, data meeting a condition; and an operator corresponding to the query execution step 303 is a Projection operator, and the Projection operator is used to output the selected data. Therefore, a function of the query plan formed by the query execution step 301 to the query execution step 303 is to: read data from the specific table, select, from the table, the data meeting the condition, and output the selected data.

In this embodiment, the query plan having the tree structure is generated, so that the computing engine can process the query execution steps in the query plan, thereby responding to the query task submitted by the user.

The query execution steps may be divided into a plurality of query execution groups, and one query execution group may include one or more query execution steps. FIG. 3 is used as an example. The query execution step 301 and the query execution step 302 may be grouped into a same query execution group, while the query execution step 303, a query execution step 304, and a query execution step 305 are grouped into different query execution groups. Therefore, all the query execution steps are divided into four query execution groups. A specific process of dividing into the query execution groups is described in detail below, and details are not described herein again.

Step 204: Sequentially schedule, according to a scheduling sequence of the plurality of query execution groups, query execution groups that meet a scheduling starting condition into an execution queue, where the scheduling starting condition corresponding to any query execution group of the plurality of query execution groups includes: a previous query execution group of the any query execution group starts to generate execution result data.

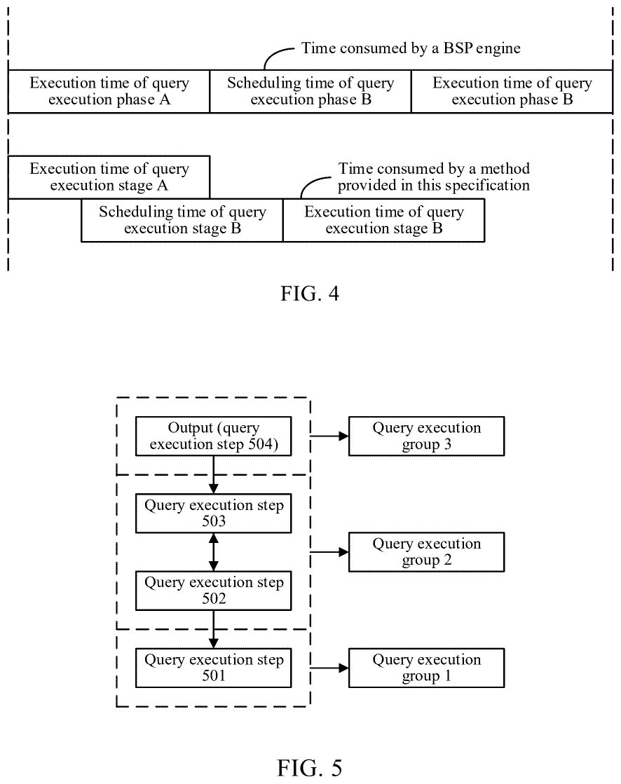

As described above, a BSP engine can schedule a next query execution phase into the execution queue only after execution of a previous query execution phase is completed. This scheduling mode is limited in efficiency. FIG. 3 is used as an example. If the query execution step 301 and the query execution step 302 belong to a query execution phase A, and the query execution step 303 belongs to a query execution phase B, for the BSP engine, the query execution phase B is scheduled into the execution queue for execution only when all field values of an A field and a B field are output in the query execution phase A. As shown in FIG. 4, time consumed by the BSP engine to execute the query execution phase A and the query execution phase B is: execution time of the query execution phase A+scheduling time of the query execution phase B+execution time of the query execution phase B.

In the query plan processing method provided in the embodiment of FIG. 2, the scheduling starting condition corresponding to any query execution group of the plurality of query execution groups is set as: the previous query execution group of the any query execution group starts to generate the execution result data. FIG. 3 is still used as an example. If the query execution step 301 and the query execution step 302 belong to the query execution stage A, and the query execution step 303 belongs to the query execution stage B, in this embodiment, the query execution stage B can be scheduled into the execution queue for execution when the query execution stage A outputs a field value of the first A field or a field value of the first B field. In this case, an execution task for the query execution stage A and a scheduling task for the query execution stage B are processed in parallel, thereby improving scheduling efficiency. As shown in FIG. 4, time consumed to execute the query execution stage A and the query execution stage B in this embodiment is less than the time consumed by the BSP engine.

A manner of determining the scheduling sequence of the query execution groups is described in detail below in the present disclosure, and details are not described herein again.

The query plan processing method provided in the present disclosure does not involve scheduling all the query execution steps into the execution queue simultaneously as an MPP engine does. Instead, the query execution steps included in the query plan are divided into the plurality of query execution groups, so that the plurality of query execution groups can be sequentially scheduled into the execution queue according to the scheduling sequence. Therefore, a complex offline task can be processed. In addition, the query plan processing method provided in the present disclosure does not involve scheduling the next query execution phase into the execution queue only after the execution of the previous query execution phase is completed as the BSP engine does. Instead, the scheduling starting condition for the query execution group is set as: the previous query execution group starts to generate the execution result data, which accelerates the efficiency of task processing. Therefore, an online task can be processed. It can be seen that according to the query plan processing method provided in the present disclosure, two types of tasks, namely, the offline task and the online task, can be handled by maintaining only one type of computing engine instead of two types of computing engines.

In this embodiment, in one aspect, the query execution steps included in the query plan are divided into the plurality of query execution groups, so that the plurality of query execution groups can be sequentially scheduled into the execution queue according to the scheduling sequence. Even if the query plan is complex, the query plan can be divided into the plurality of query execution groups for sequential scheduling, thereby implementing processing of a complex offline task. In another aspect, the scheduling starting condition for the plurality of query execution groups is set as: the previous query execution group starts to generate the execution result data, so that any query execution group can be scheduled into the execution queue when the previous query execution group starts to generate the execution result data, instead of being scheduled into the execution queue only when execution of the previous query execution group is completed. This improves scheduling efficiency of the query execution groups, thereby accelerating a speed of responding to an online task. In addition, because the foregoing method can not only process the complex offline task, but also quickly respond to the online task, the foregoing method can meet the requirement of the real-time data warehouse through operations and maintenance of only one type of computing engine, thereby reducing operations and maintenance costs, and reducing complexity of user operations.

In an embodiment, the dividing the query execution steps included in the query plan into the plurality of query execution groups includes: constructing a dependency topology graph with the query execution steps as nodes and dependency relationships among the query execution steps as edges, and grouping query execution steps corresponding to a circular dependency relationship in the dependency topology graph into a same query execution group.

There are the dependency relationships among the to-be-scheduled execution steps. For example, an output result of a to-be-scheduled execution step A is an input of a to-be-scheduled execution step B. In this case, it can be said that the to-be-scheduled execution step B depends on the to-be-scheduled execution step A. Certainly, a case where two to-be-scheduled execution steps depend on each other also exists. For example, the first value x output by the to-be-scheduled execution step A is the first value input by the to-be-scheduled execution step B, and a value y can be calculated according to x by the to-be-scheduled execution step B. The value y may be the first value output by the to-be-scheduled execution step B and the second value input by the to-be-scheduled execution step A. The second value output by the to-be-scheduled execution step A is a value z calculated according to the value y, and the value z is the second value input by the to-be-scheduled execution step B. Therefore, the output of each of the to-be-scheduled execution step A and the to-be-scheduled execution step B is the input to the other, that is, the to-be-scheduled execution step A and the to-be-scheduled execution step B depend on each other.

Certainly, mutual dependency may exist among more than two to-be-scheduled execution steps, and three to-be-scheduled execution steps can also depend on each other. For example, an output of the to-be-scheduled execution step A is an input of the to-be-scheduled execution step B, an output of the to-be-scheduled execution step B is an input of a to-be-scheduled execution step C, and an output of the to-be-scheduled execution step C is an input of the to-be-scheduled execution step A. In this case, the to-be-scheduled execution step A, the to-be-scheduled execution step B, and the to-be-scheduled execution step C depend on each other. Similarly, mutual dependency may also exist among a larger number of to-be-scheduled execution steps.

When the dependency topology graph is constructed with the query execution steps as the nodes and the dependency relationships among the query execution steps as the edges, a circular dependency relationship is formed among the to-be-scheduled execution steps depending on each other. As shown in FIG. 5, in a case where a to-be-scheduled execution step 502 depends on a to-be-scheduled execution step 501, an arrow “pointing from the to-be-scheduled execution step 502 to the to-be-scheduled execution step 501” may be constructed between the to-be-scheduled execution step 501 and the to-be-scheduled execution step 502. In addition, the to-be-scheduled execution step 502 and a to-be-scheduled execution step 503 depend on each other. Therefore, a circular dependency relationship is formed. Because to-be-scheduled execution steps depending on each other need to be executed in parallel in the execution queue, to-be-scheduled execution steps corresponding to the circular dependency relationship need to be scheduled into the execution queue simultaneously. Otherwise, a deadlock problem is likely to occur. Therefore, the to-be-scheduled execution steps corresponding to the circular dependency relationship need to be grouped into a same query execution group. As shown in FIG. 5, the to-be-scheduled execution step 501 is grouped into a query execution group 1, the to-be-scheduled execution step 502 and the to-be-scheduled execution step 503 are grouped into a query execution group 2, and a to-be-scheduled execution step 504 is grouped into a query execution group 3. A sequence of scheduling the query execution groups into the execution queue is: the query execution group 1, the query execution group 2, and the query execution group 3.

In this embodiment, the dependency topology graph is constructed according to the dependency relationships among the to-be-scheduled execution steps, so that the computing engine can group the to-be-scheduled execution steps depending on each other into a same scheduling execution group, thereby avoiding occurrence of the deadlock problem.

In an embodiment, the query execution steps include strong blocking steps, the strong blocking step includes at least one strong blocking operator, and the strong blocking operator is an operator that starts to be executed only after all data is collected; and the dividing the query execution steps included in the query plan into the plurality of query execution groups includes: dividing different strong blocking steps into different query execution groups.

Each query execution step includes one or more database operators. The database operator may be understood as a specific action of a query execution step in the query plan. For example, common SQL clauses such as SELECT, FROM, and JOIN are operators.

Database operators may be classified, according to semantics and physical implementation, into two types: streaming operators that do not require data collection and strong blocking operators that require data collection. The strong blocking operators include a hash join operator, a sort operator, a hash aggregation operator, and the like. Such type of operators needs to collect all input data in a computational process before starting to output computed data. The streaming operators include a filter operator, a project operator, and a scan operator. Such type of operators can start computation and output data when receiving only a part of data.

If one query execution group includes two strong blocking steps, the two strong blocking steps will affect each other, resulting in slowing down. For example, a previous strong blocking step starts to output computed data only after collecting data in all previous steps. Similarly, a next strong blocking step can only complete data collection and start to output computed data after the previous strong blocking step has completed data output. Therefore, dividing the different strong blocking steps into the different query execution groups can improve step execution efficiency.

In this embodiment, the different strong blocking steps are divided into the different query execution groups, so that a finer-grained division of the query execution groups is implemented, thereby improving efficiency of scheduling the query execution groups into the query queue, and further improving query efficiency.

In an embodiment, the method further includes: determining dependency relationships among the plurality of query execution groups according to the dependency relationships among the query execution steps, and determining the scheduling sequence according to the dependency relationships among the plurality of query execution groups.

As described above, there are the dependency relationships among the query execution steps. When a query execution step B depends on a query execution step A, the query execution step A needs to be executed before the query execution step B. If the execution sequence of the two steps is reversed, the deadlock problem may occur. There are also the dependency relationships among the query execution groups including the query execution steps, and the dependency relationships among the query execution groups can be determined according to the dependency relationships among the query execution steps. FIG. 5 is used as an example. Because the query execution step 502 depends on the query execution step 501, the query execution group 2 depends on the query execution group 1; and because the query execution step 504 depends on the query execution step 503, the query execution group 3 depends on the query execution group 2. Therefore, it can be determined that, from front to back, the scheduling sequence of the query execution groups is: the query execution group 1, the query execution group 2, and the query execution group 3.

In this embodiment, the dependency relationships among the query execution groups are determined according to the dependency relationships among the query execution steps, and the scheduling sequence is determined according to the dependency relationships among the query execution groups, thereby avoiding a deadlock problem caused by a disordered scheduling sequence of the query execution groups.

In an embodiment, the plurality of query execution groups include a first query execution group and a second query execution group, and output data of the first query execution group includes at least a part of input data of the second query execution group; the method further includes: determining a distributed data shuffle manner for the first query execution group and the second query execution group according to data volume of the output data of the first query execution group; and processing the output data of the first query execution group according to the determined distributed data shuffle manner, and shuffling processed data to the second query execution group.

Distributed data shuffle is data shuffle across nodes and processes within a cluster. In a query plan processing scenario, if the Shuffle is required between a previous query execution step and a next query execution step, the Shuffle is also required between query execution groups.

Further, the distributed data shuffle manner includes: a memory-based distributed data shuffle manner and a distributed data shuffle manner based on disk read and write; and the processing the output data of the first query execution group according to the determined distributed data shuffle manner includes: processing the output data according to the memory-based distributed data shuffle manner when the data volume of the data is less than a preset threshold; and processing the output data according to the distributed data shuffle manner based on disk read and write when the data volume of the data is not less than the preset threshold.

For the memory-based distributed data shuffle manner, the data is placed in memory for data shuffle. Because a read-write rate of the memory is high, this manner has high execution efficiency, but occupies a relatively large amount of memory. For the distributed data shuffle manner based on disk read and write, the data is placed in a disk for data shuffle. This manner has a limited execution rate, but occupies a relatively small amount of memory. Therefore, the Shuffle manner can be determined according to the data volume of the output data of the first query execution group.

The phased scheduling algorithm used by the BSP engine limits the data shuffle manner to the distributed data shuffle manner based on disk read and write, because the BSP engine is mostly configured to process an offline task having relatively large data volume. However, the query plan scheduling method provided in the present disclosure needs to handle both the offline task with relatively large data volume and the online task with relatively small data volume. Therefore, the distributed data shuffle manner cannot be limited.

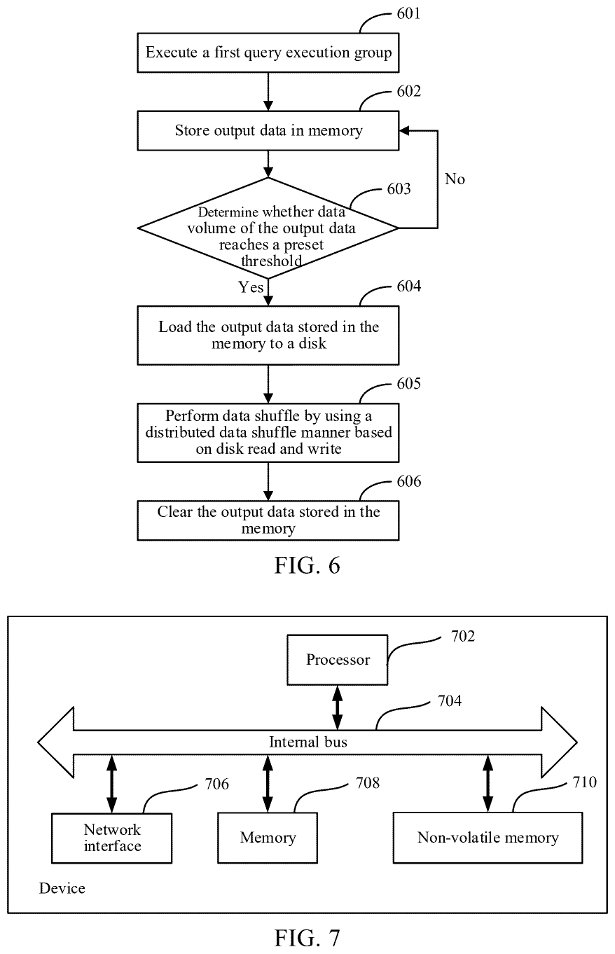

The following describes a specific determining manner in detail with reference to FIG. 6. FIG. 6 is a flowchart of a data shuffle method according to an exemplary embodiment. As shown in FIG. 6, the method includes at least the following steps.

Step 601: Execute a first query execution group.

Step 602: Store output data in memory. By default, data shuffle may be first performed by using a memory-based distributed data shuffle manner, that is, by storing the output data in the memory.

Step 603: Determine whether data volume of the output data reaches a preset threshold. The preset threshold may be 1 GB.

When the data volume of the output data of the first query execution group does not reach 1 GB, the data shuffle continues being performed by using the memory-based distributed data shuffle manner, that is, step 602 continues being performed, to store the output data in the memory.

When the data volume of the output data of the first query execution group reaches 1 GB, Step 604 is performed to load the output data stored in the memory into a disk.

Step 605: Perform data shuffle by using a distributed data shuffle manner based on disk read and write.

Step 606: Clear the output data stored in the memory.

After the data shuffle is performed by using the distributed data shuffle manner based on disk read and write, the output data previously stored in the memory can be cleared, to avoid memory occupation.

In this embodiment, the distributed data shuffle manner is switched based on the data volume of the output data of the first query execution group, so that the data shuffle is not limited to one manner, thereby implementing real-time adjustment of the data shuffle manner, and considering both data shuffle efficiency and memory resource occupation.

Certainly, the specific determining manner is not limited thereto, and may be determined according to a user requirement. This is not limited in the present disclosure.

In this embodiment, the distributed data shuffle manner is switched through the data volume of the output data of the first query execution group, so that the data shuffle is not limited to one manner, thereby implementing real-time adjustment of the data shuffle manner, and considering both data shuffle efficiency and memory resource occupation.

FIG. 7 is a schematic structural diagram of a device according to an exemplary embodiment. Referring to FIG. 7, at a hardware level, the device includes a processor 702, an internal bus 704, a network interface 706, memory 709, and a non-volatile memory 710. Certainly, the device may further include hardware required for other functions. One or more embodiments of the present disclosure may be implemented in a software-based manner. For example, the processor 702 reads a corresponding computer program from the non-volatile memory 710 into the memory 708 and then runs the computer program. Certainly, in addition to software-based implementation, the one or more embodiments of the present disclosure do not preclude other implementations, such as use of a logical device or a combination of software and hardware. In other words, an execution body of the following processing procedures is not limited to logical units, but may alternatively be hardware or a logical device.

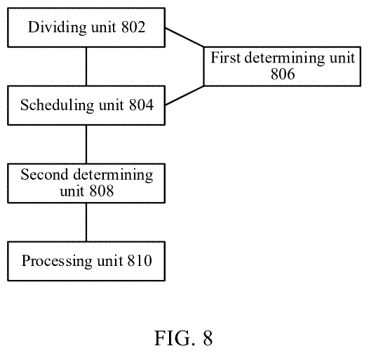

Please refer to FIG. 8. A query plan processing apparatus may be applied in the device shown in FIG. 8, to implement the technical solutions of the present disclosure. The apparatus may include:
a dividing unit 802, configured to divide, in response to a to-be-executed query plan, query execution steps included in the query plan into a plurality of query execution groups; and
a scheduling unit 804, configured to sequentially schedule, according to a scheduling sequence of the plurality of query execution groups, query execution groups that meet a scheduling starting condition into an execution queue, where the scheduling starting condition corresponding to any query execution group of the plurality of query execution groups includes: a previous query execution group of the any query execution group starts to generate execution result data.

In an implementation, the dividing unit 802 is specifically configured to:
construct a dependency topology graph with the query execution steps as nodes and dependency relationships among the query execution steps as edges, and group query execution steps corresponding to a circular dependency relationship in the dependency topology graph into a same query execution group.

In an implementation, the query execution steps include strong blocking steps, the strong blocking step includes at least one strong blocking operator, and the strong blocking operator is an operator that starts to be executed only after all data is collected; and the dividing unit 802 is specifically configured to:
divide different strong blocking steps into different query execution groups.

In an implementation, the apparatus further includes:
a first determining unit 806, configured to determine dependency relationships among the plurality of query execution groups according to the dependency relationships among the query execution steps, and determine the scheduling sequence according to the dependency relationships among the plurality of query execution groups.

In an implementation, the plurality of query execution groups include a first query execution group and a second query execution group, and output data of the first query execution group includes at least a part of input data of the second query execution group; and the apparatus further includes:
a second determining unit 808, configured to determine a distributed data shuffle manner for the first query execution group and the second query execution group according to data volume of the output data of the first query execution group; and
a processing unit 810, configured to process the output data of the first query execution group according to the determined distributed data shuffle manner, and shuffle processed data to the second query execution group.

In an implementation, the distributed data shuffle manner includes: a memory-based distributed data shuffle manner and a distributed data shuffle manner based on disk read and write; and the processing unit 810 is specifically configured to:
process the output data according to the memory-based distributed data shuffle manner when the data volume of the data is less than a preset threshold; and
process the output data according to the distributed data shuffle manner based on disk read and write when the data volume of the data is not less than the preset threshold.

A system, an apparatus, a module, or a unit described in the foregoing embodiments can be specifically implemented by a computer chip or a computer entity, or implemented by a product having a certain function. A typical implementation device is a computer. A specific form of the computer may be a personal computer, a laptop computer, a cellular phone, a camera phone, a smart phone, a personal digital assistant, a media player, a navigation device, an email transceiver device, a game console, a tablet computer, a wearable device, or a combination of several of these devices.

In a typical configuration, the computer includes one or more processors (CPUs), an input/output interface, a network interface, and memory.

The memory may include a non-permanent memory in computer-readable media, such as a random-access memory (RAM), and/or a non-volatile memory in computer-readable media, such as a read-only memory (ROM) or a flash memory (flash RAM). The memory is an example of the computer-readable media.

The computer-readable media include permanent, non-permanent, removable, and non-removable media, which can implement storage of information by using any method or technology. The information may be computer-readable instructions, a data structure, a program module, or other data. Examples of a computer storage medium include, but are not limited to, a phase-change memory (PRAM), a static random-access memory (SRAM), a dynamic random-access memory (DRAM), other types of random-access memory (RAM), a read-only memory (ROM), an electrically erasable programmable read-only memory (EEPROM), a flash memory or other memory technologies, a compact disc read-only memory (CD-ROM), a digital versatile disc (DVD) or other optical storages, a magnetic cassette, a magnetic disk storage, a quantum memory, a graphene-based storage medium, or other magnetic storage devices or any other non-transitory medium that can be used to store information accessible by a computing device. According to the definitions in this specification, the computer-readable medium does not include transitory computer-readable media (transitory media), such as a modulated data signal and a carrier.

For any computer-readable medium (or referred to as a computer-readable storage medium) as described above or in any other form, computer instructions may be stored thereon, and when the instructions are executed by a processor, one or more of the foregoing embodiments are implemented, thereby implementing the technical solutions of the present disclosure.

The present disclosure further provides a computer program. When the program is executed by a processor, one or more of the foregoing embodiments are implemented, thereby implementing the technical solutions of the present disclosure. The computer program can be specifically recorded in the computer-readable medium as described above or in any other form. This is not limited in the present disclosure.

It should be further noted that the terms “comprise”, “include”, or any other variants thereof are intended to cover a non-exclusive inclusion, so that a process, method, commodity, or device that includes a list of elements not only includes those elements, but also includes other elements not expressly listed or includes elements inherent to such process, method, commodity, or device. Without more constraints, an element defined by “include a/an/one . . . ” does not preclude the existence of additional identical elements in the process, method, commodity, or device that includes the element.

Specific embodiments of the present disclosure are described above. Other embodiments fall within the scope of the appended claims. In some cases, actions or steps recorded in the claims may be performed in a sequence different from the sequence in the embodiments, and an expected result can still be achieved. In addition, the processes illustrated in the accompanying drawings do not necessarily require the shown particular sequence or the consecutive sequence to achieve the expected result. In some implementations, multitasking processing and parallel processing may also be possible or advantageous.

The terms used in one or more embodiments of the present disclosure are merely for describing a particular embodiment, but are not intended to limit the one or more embodiments of the present disclosure. The singular forms “a/an”, “said” and “the” used in the one or more embodiments and the appended claims of the present disclosure are also intended to include plural forms, unless the context clearly indicates otherwise. It should be further understood that the term “and/or” used in this specification refers to and includes any possible combination or all possible combinations of one or more associated listed items.

It should be understood that in the one or more embodiments of this present disclosure, though the terms such as first, second, and third may be used to describe various information, the information should not be limited to the terms. These terms are merely used to distinguish between information of a same type. For example, without departing from the scope of the one or more embodiments of the present disclosure, first information may also be referred to as second information, and similarly, second information may also be referred to as first information. Depending on the context, for example, the word “if” used herein may be explained as “in a case where”, “when”, or “in response to determining”.

The foregoing descriptions are merely preferred embodiments of the one or more embodiments of the present disclosure, but are not intended to limit the one or more embodiments of the present disclosure. Any modification, equivalent replacement, or improvement made within the spirit and principle of the one or more embodiments of the present disclosure shall fall within the protection scope of the one or more embodiments of the present disclosure.

1. A query plan processing method, comprising:
dividing, in response to a to-be-executed query plan, query execution steps comprised in the query plan into a plurality of query execution groups; and
sequentially scheduling, according to a scheduling sequence of the plurality of query execution groups, query execution groups that meet a scheduling starting condition into an execution queue, wherein the scheduling starting condition corresponding to any query execution group of the plurality of query execution groups comprises: a previous query execution group of the any query execution group starts to generate execution result data.

2. The method according to claim 1, wherein the dividing the query execution steps comprised in the query plan into the plurality of query execution groups comprises:
constructing a dependency topology graph with the query execution steps as nodes and dependency relationships among the query execution steps as edges, and grouping query execution steps corresponding to a circular dependency relationship in the dependency topology graph into a same query execution group.

3. The method according to claim 1, wherein the query execution steps comprise strong blocking steps, each strong blocking step comprises at least one strong blocking operator, and the strong blocking operator is an operator that starts to be executed only after all data is collected; and the dividing the query execution steps comprised in the query plan into the plurality of query execution groups comprises:
dividing different strong blocking steps into different query execution groups.

4. The method according to claim 1, further comprising:
determining dependency relationships among the plurality of query execution groups according to the dependency relationships among the query execution steps, and determining the scheduling sequence according to the dependency relationships among the plurality of query execution groups.

5. The method according to claim 1, wherein the plurality of query execution groups comprise a first query execution group and a second query execution group, and output data of the first query execution group comprises at least a part of input data of the second query execution group; and the method further comprises:
determining a distributed data shuffle manner for the first query execution group and the second query execution group according to data volume of the output data of the first query execution group; and
processing the output data of the first query execution group according to the determined distributed data shuffle manner, and shuffling processed data to the second query execution group.

6. The method according to claim 5, wherein the distributed data shuffle manner comprises: a memory-based distributed data shuffle manner and a distributed data shuffle manner based on disk read and write; and the processing the output data of the first query execution group according to the determined distributed data shuffle manner comprises:
processing the output data according to the memory-based distributed data shuffle manner when the data volume of the data is less than a preset threshold; and
processing the output data according to the distributed data shuffle manner based on disk read and write when the data volume of the data is not less than the preset threshold.

7. A query plan processing apparatus, comprising:
a processor; and
a memory, configured to store processor-executable instructions;
wherein by running the executable instructions, the processor is configured to:
a divide, in response to a to-be-executed query plan, query execution steps comprised in the query plan into a plurality of query execution groups; and
sequentially schedule, according to a scheduling sequence of the plurality of query execution groups, query execution groups that meet a scheduling starting condition into an execution queue, wherein the scheduling starting condition corresponding to any query execution group of the plurality of query execution groups comprises: a previous query execution group of the any query execution group starts to generate execution result data.

8. (canceled)

9. A non-transitory computer-readable storage medium, storing computer instructions, wherein when the instructions are executed by a processor, the following operations are implemented:
dividing, in response to a to-be-executed query plan, query execution steps comprised in the query plan into a plurality of query execution groups; and
sequentially scheduling, according to a scheduling sequence of the plurality of query execution groups, query execution groups that meet a scheduling starting condition into an execution queue, wherein the scheduling starting condition corresponding to any query execution group of the plurality of query execution groups comprises: a previous query execution group of the any query execution group starts to generate execution result data.

10. (canceled)

11. The method according to claim 2, further comprising:
determining dependency relationships among the plurality of query execution groups according to the dependency relationships among the query execution steps, and determining the scheduling sequence according to the dependency relationships among the plurality of query execution groups.

12. The method according to claim 2, wherein the plurality of query execution groups comprise a first query execution group and a second query execution group, and output data of the first query execution group comprises at least a part of input data of the second query execution group; and the method further comprises:
determining a distributed data shuffle manner for the first query execution group and the second query execution group according to data volume of the output data of the first query execution group; and
processing the output data of the first query execution group according to the determined distributed data shuffle manner, and shuffling processed data to the second query execution group.

13. The apparatus according to claim 7, wherein the processor is specifically configured to:
construct a dependency topology graph with the query execution steps as nodes and dependency relationships among the query execution steps as edges, and group query execution steps corresponding to a circular dependency relationship in the dependency topology graph into a same query execution group.

14. The apparatus according to claim 7, wherein the query execution steps comprise strong blocking steps, each strong blocking step comprises at least one strong blocking operator, and the strong blocking operator is an operator that starts to be executed only after all data is collected; and the processor is specifically configured to:
divide different strong blocking steps into different query execution groups.

15. The apparatus according to claim 7, wherein the processor is further configured to:
determine dependency relationships among the plurality of query execution groups according to the dependency relationships among the query execution steps, and determine the scheduling sequence according to the dependency relationships among the plurality of query execution groups.

16. The apparatus according to claim 7, wherein the plurality of query execution groups comprise a first query execution group and a second query execution group, and output data of the first query execution group comprises at least a part of input data of the second query execution group; and the processor is further configured to:
determine a distributed data shuffle manner for the first query execution group and the second query execution group according to data volume of the output data of the first query execution group; and
process the output data of the first query execution group according to the determined distributed data shuffle manner, and shuffle processed data to the second query execution group.

17. The apparatus according to claim 16, wherein the distributed data shuffle manner comprises: a memory-based distributed data shuffle manner and a distributed data shuffle manner based on disk read and write; and the processor is specifically configured to:
process the output data according to the memory-based distributed data shuffle manner when the data volume of the data is less than a preset threshold; and
process the output data according to the distributed data shuffle manner based on disk read and write when the data volume of the data is not less than the preset threshold.

18. The non-transitory computer-readable storage medium according to claim 9, wherein the dividing the query execution steps comprised in the query plan into the plurality of query execution groups comprises:
constructing a dependency topology graph with the query execution steps as nodes and dependency relationships among the query execution steps as edges, and grouping query execution steps corresponding to a circular dependency relationship in the dependency topology graph into a same query execution group.

19. The non-transitory computer-readable storage medium according to claim 9, wherein the query execution steps comprise strong blocking steps, each strong blocking step comprises at least one strong blocking operator, and the strong blocking operator is an operator that starts to be executed only after all data is collected; and the dividing the query execution steps comprised in the query plan into the plurality of query execution groups comprises:
dividing different strong blocking steps into different query execution groups.

20. The non-transitory computer-readable storage medium according to claim 9, wherein when the instructions are executed by the processor, the following operations are further implemented:
determining dependency relationships among the plurality of query execution groups according to the dependency relationships among the query execution steps, and determining the scheduling sequence according to the dependency relationships among the plurality of query execution groups.

21. The non-transitory computer-readable storage medium according to claim 9, wherein the plurality of query execution groups comprise a first query execution group and a second query execution group, and output data of the first query execution group comprises at least a part of input data of the second query execution group; and when the instructions are executed by the processor, the following operations are further implemented:
determining a distributed data shuffle manner for the first query execution group and the second query execution group according to data volume of the output data of the first query execution group; and
processing the output data of the first query execution group according to the determined distributed data shuffle manner, and shuffling processed data to the second query execution group.

22. The non-transitory computer-readable storage medium according to claim 21, wherein the distributed data shuffle manner comprises: a memory-based distributed data shuffle manner and a distributed data shuffle manner based on disk read and write; and the processing the output data of the first query execution group according to the determined distributed data shuffle manner comprises:
processing the output data according to the memory-based distributed data shuffle manner when the data volume of the data is less than a preset threshold; and
processing the output data according to the distributed data shuffle manner based on disk read and write when the data volume of the data is not less than the preset threshold.
